(19) United States
(12) Patent Application Publication
(10) Pub. No.: US 2010/0056661 A1
(43) Pub. Date: Mar. 4, 2010

(54) Radiation Curable Compositions Useful in Image Projection Systems

(76) Inventor: Pingyong Xu, Valencia, CA (US)

Correspondence Address: 3D Systems, Inc.;Attn: Keith A. Roberson, 333 Three D Systems Circle, Rock Hill, SC, 29730, US

(21) Appl. No.: 12/203,177

(22) Filed: Sep. 3, 2008

(51) Int. Cl. C08L 33/00; C08K 3/36

(52) U.S. Cl. 522/53; 522/113; 522/71

(57) ABSTRACT

A radiation-curable composition useful for the production of three-dimensional solid articles is provided. The radiation-curable composition comprises at least one hyperbranched poly(meth)acrylate compound, at least one light sensitizer, and at least one free radical polymerization initiator.

### FIELD OF THE INVENTION

The present invention relates to radiation curable compositions useful in light image projection systems. More preferably, the present invention relates to (meth)acrylate-based compositions that contain two or more free radical photoinitiators in both the visible and UV light ranges.

### BACKGROUND OF THE INVENTION

Image projection systems are a recent development in the three-dimensional solid imaging field. Such systems are an alternative to stereolithographic solid imaging systems using laser scanning. Image projection systems may use a combination of UV light and visible light to initiate and complete photocuring of the three-dimensional solid articles, objects, parts, prototypes, or the like. They are an extremely low cost approach to solid imaging when compared to stereolithographic systems that use more expensive laser beams to initiate photocuring. The image projection process may employ either an endless or a retractable flexible, light-permeable belt or film coated with a radiation curable resin that is moved through an exposure station where a digital light projector imagewise exposes the resin through the light-permeable belt or film to imagewise solidify and form a cured resin layer. After this imagewise exposure and curing, the imaged and cured resin layer is separated from the belt and remains adhered to the build platform on top of previously exposed layers. This process is then repeated until a desired three-dimensional object is made. Resin layers are repeatedly coated onto the endless belt and then imagewise exposed. Each solid resin layer is then separated from the belt and remains adhered to the support platform with subsequent exposed layers until the completed object is formed.

An example of an image projection system employing an endless belt is disclosed in US Patent Application Publication No. 2007/0259066. Examples of image projection systems employing a retractable film are disclosed in US Patent Application Publication Nos. 2008/01 69589 and 2008/0206383. These latter patent applications relate to the V-FLASH® film transfer imaging system available from 3D Systems Corporation of Rock Hill, S.C. These patent applications are incorporated herein by reference in their entireties.

The curable resins used in such image projection systems need to have a combination of desirable properties. Preferably, such resins should have little or no surface tackiness and should have reduced adhesion properties so they can be easily removed from the endless belt, yet have sufficient physical properties so that they form useful three-dimensional objects. Further, it is well known that UV curable straight (meth)acrylate resins of this type generally have shrinkage and distortion problems similar to mixed epoxy/acrylate resin systems. Trying to correct these shrinkage and distortion problems in straight (meth)acrylate resins systems can cause the photospeed of the resin to undesirably decrease. Still further, it is also desirable to produce a dry part that the end user can handle without any danger of sensitization resulting from skin contact with the formed three-dimensional object. Examples of such curable resins are disclosed in U.S. Pat. No. 7,358,283, which issued on Apr. 15, 2008, which is incorporated herein by reference in its entirety. While such straight (meth)acrylate resins are suitable for use in making three dimensional articles with image projector systems, there is still a need for better straight (meth)acrylate resins that cure faster and more thoroughly while having better coating uniformity, especially on hard surfaces like TEFLON-type transfer films disclosed in the above-noted patent applications related to the V-FLASH system. The present invention offers solutions to those and other needs.

### BRIEF SUMMARY OF THE INVENTION

One aspect of the present invention is directed to a radiation-curable composition useful for the production of three-dimensional solid articles by light image projection systems, said composition comprises:
(A) at least one hyperbranched poly(meth)acrylate compound;
(B) at least one light sensitizer; and
(C) at least one free radical polymerization initiator.

Still another aspect of the present invention is directed to three-dimensional solid articles made from the above-noted curable composition by an image projection system.

Therefore, one aspect of the present invention is directed to a radiation-curable straight (meth)acrylate composition useful for the production of three-dimensional solid articles by image projection systems, said composition comprises:
(A) at least one hyperbranched polyester poly(meth)acrylate compound;
(B) at least one UV light sensitizer;
(C1) at least one visible light range free radical polymerization initiator; and
(C2) at least one UV light range free radical polymerization initiator.
(D) at least one urethane poly(meth)acrylate compound;
(E) at least one poly(meth)acrylate compound; and
(F) at least one non-hyperbranched polyester poly(meth)acrylate compound.

Still another aspect of the present invention is directed to three-dimensional solid articles made from the above-noted curable composition by an image projection system.

The above compositions of the present invention offer several advantages. The compositions are easily released from various transfer films and are cured relatively quickly to be tack free. Another advantage of the present invention is to provide cured three-dimensional objects with a desirable combination of physical and mechanical properties. Another advantage is the present composition provides a resin material that permits the use of reliable image projection processes to produce high quality three-dimensional parts. Still further, the compositions of the present invention may have better coating properties on low surface tension surfaces such as TEFLON-like surfaces.

### DETAILED DESCRIPTION OF THE INVENTION

The term “(meth)acrylate” as used in present specification and claims refers to both acrylates and methacrylates.

The term “poly(meth)acrylate” as used in the present specification refers to both acrylates and methacrylates that have more than one acrylate or methacrylate functionality. Examples include diacrylates, triacrylates, tetraacrylates, pentaacrylates, dimethacrylates, trimethacrylates, tetramethacrylates and pentamethacrylates.

The term “straight (meth)acrylate resin system” as used in the present specification refers to resin formulations that contain one or more (meth)acrylate compounds but no epoxy compounds and are useful for making three dimensional solid articles, preferably with the use of a image projector system.

It is to be understood that the term “light” as used in the present specification can mean electromagnetic radiation in the wavelength range including infrared, visible, ultraviolet and x rays, that when traveling in a vacuum moves with a speed of about 186,281 miles per second or 300,000 kilometers per second. Accordingly, “light” as used herein includes but is not limited to any and all forms of actinic radiation.

The novel compositions of the present invention contain a mixture of several separate components or compounds listed above. The compositions may contain these separate ingredients in any proportion that would be useful as radiation-curable compositions in light image projection systems. These compositions may further optionally contain colorants and other additives. Preferably, the compositions of the present invention do not contain silicone poly(meth)acrylate compounds.

### (A) Hyperbranched Poly(meth)acrylate Compounds

The first component of the composition of present invention is at least one hyperbranched poly(meth)acrylate. From a structural standpoint, hyperbranched oligomers are quite different from typical oligomers used in radiation cure applications. They have a “globular” morphology rather than the typical linear morphology. Because of these structural differences, they possess beneficial properties for such curing applications. See the Sartomer publication dated March 2008 by J. A. Klang entitled “Radiation Curable Hyperbranched Polyester Acrylates” for a detailed discussion of these compounds. For the present invention, a preferred example of this first component is SARTOMER CN2302 hyperbranched polyester poly(meth)acrylate available from the Sartomer Company. Other hyperbranched polyester acrylate compounds that may be suitable for the present invention include CN2300, CN2301, CN2303, and CN2304, all available from Sartomer and discussed in the Klang article. Of course, other hyperbranched polyester poly(meth)acrylate compounds and mixtures of hyperbranched compounds may be used if they are able to produce useful three-dimensional articles. In certain preferred embodiments of the present invention, the hyperbranched polyester poly(meth)acrylate compound constitutes about 3% to about 20% by weight of the total composition.

### (B) Light Sensitizers

The second component of the compositions of the present invention is at least one light sensitizer compound. Light sensitizers have been used before in stereolithographic resin composition as an optional compound. In the compositions of the present invention, sensitizers are used to shorten the surface curing time period so that through-put time for making a three-dimensional article is improved. Preferably, the at least one light sensitizer is at least one UV light sensitizer. One preferred UV light sensitizer is Additol ITX isopropyl thioxanthone available from Cytec. Of course, other thioxanthone UV light sensitizers as well as other useful light sensitizers and mixtures of sensitizers including mixtures of visible light sensitizers and UV light sensitizers may be used in the present invention for making three-dimensional articles. In certain preferred embodiments of the present invention, the sensitizer(s) constitutes about 0.005% to about 1% by weight of the total composition.

### (C) Free Radical Polymerization Initiators (Photoinitators)

The third component of the compositions of the present invention is at least one free radical polymerization initiator (also called photoinitiators). While a single photoinitiator may be used in this invention, it is preferred to use a combination of at least one visible light range photoinitiator and at least one UV light range photoinitiator, especially when an image projecting system is used to produce the three-dimensional object. In certain preferred embodiments of the present invention, the total amount of photoinitiators is about 1% to about 10% by weight of the total resin composition.

### (C1) Visible Light Range Free Radical Polymerization Initiators

The visible light range free radical polymerization initiator(s) can be any free radical polymerization initiator that will start a free radical reaction when exposed to radiation in the spectral range including about 350 nanometers to about 500 nanometers. The preferred visible light range free radical polymerization initiator(s) is bis(2,4,6-trimethylbenzoyl)-phenylphosphine oxide which is available as IRGACURE 819 form Ciba Specialty Chemicals, Inc.

The visible light range free radical polymerization initiator(s) is preferably present in an amount from about 0.5% to about 7% by weight, based on the total weight of the composition; more preferably, from about 1% to about 5% by weight of the total composition.

### (C2) UV Light Range Free Radical Polymerization Initiators

The UV light range free radical polymerization initiator(s) can be any free radical polymerization initiator(s) that will start a free radical reaction when exposed to radiation in the UV light spectrum (including about 260 nanometers to about 380 nanometers). The preferred UV light range free radical polymerization initiator(s) is 1-hydroxycyclohexyl phenyl ketone that is available as IRGACURE I-184 from Ciba Specialty Chemicals, Inc.

The UV light range free radical polymerization initiator(s) is preferably present in amount from about 0.5% to about 7% by weight of the total composition; more preferably from about 1% to about 6% by weight of the total composition.

### (D) Urethane Poly(meth)acrylate Compounds

The compositions of the present invention may also preferably contain at least one urethane poly(meth)acrylate compound. Preferably, this compound is a urethane di(meth)acrylate compound. More preferably, this compound is a urethane diacrylate oligomer such as Sartomer CN9011 available from Sartomer Company of Exton, Pa.

The urethane poly(meth)acrylate compound or compounds preferably constitute from about 10% to 40% by weight of the total composition; more preferably, from about 20% to about 35% by weight of the total composition.

### (E) Poly(meth)acrylate Compounds

The composition of the present invention may also preferably contain at least one poly(meth)acrylate compound. This component (E) is different than the other components in this composition. Preferably, this component is a diacrylate monomer that may be polymerized by free radicals. More preferably, this component is tricyclodecane dimethanol diacrylate monomer such as Sartomer SR833S available from Sartomer Company. This compound can be used in a variety of applications wherein both flexibility and toughness are required.

The poly(meth)acrylate compound or compounds preferably constitute from about 20% to about 55% by weight of the total composition; more preferably, from about 25% to about 50% by weight of the total composition.

### (F) Non-Hyperbranched Polyester Poly(meth)acrylate Compounds

Besides the above-described components, the present invention may also preferably include at least one non-hyperbranched polyester poly(meth)acrylate compound.

Preferably, the non-hyperbranched polyester poly(meth)acrylate compound or compounds constitute from about 5% to about 30% by weight of the total composition; more preferably, from about 10% to about 25% by weight of the total composition.

One preferred embodiment of the present invention includes two such compounds. One compound is a low viscosity amine-modified polyacrylate polyester oligomer such as Ebecryl 83 available from UCB Chemicals Corp. of Smyrna, Ga. The second compound is an amine-modified polyester tetraacrylate such as SARTOMER 80 also available from the Sartomer Company. In one preferred embodiment, the combination of these two amine-modified non-hyperbranched polyester poly(meth)acrylate compounds is employed.

### (G) Other Optional Additives

If necessary, the resin composition for image applications according to the present invention may contain other materials in suitable amounts, as far as the effect of the present invention is not adversely affected. Examples of such materials include coloring agents such as pigments and dyes, fillers, antifoaming agents, leveling agents, thickening agents, flame retardants, and antioxidants.

One preferred class of additives is colorants, particularly pigments. These are included to add color to the resultant cured product. Two suitable pigments are Penn Color 9W7 white pigment and Penn Color 9S4 blue pigment, both available from Penn Color Inc. of Doylestown, Pa. It is preferred to use such pigments in amounts from about 0.005% to about 1% by weight of the total curable resin composition.

Another preferred optional material is a leveling agent such as one of the MODAFLOW leveling agents available from Cytec Industries. If used, it is preferably present in a amount from about 0.05% to about 1% by weight of the total curable resin composition.

Still another preferred optional component is fumed silica. A preferred one is AEROSIL R202 available from Evonik Degussa GmbH. If used, it is preferably present in an amount from about 0.25% to about 2% by weight. This component provides better coating uniformity to the compositions of the present invention on very low surface tension surfaces used in the V-FLASH systems described in the above-noted US patent applications.

### Formulation Preparation

The novel compositions can be prepared in a known manner by, for example, premixing individual components and then mixing these premixes, or by mixing all of the components using customary devices, such as stirred vessels, in the absence of light, if desired, at slightly elevated temperature. Preferably, the preferred formulations of the present invention are mixed together in a suitable manner and then placed in light-tight cartridges employed with the V-FLASH film transfer imaging systems described above and in the US patent applications cited above.

### Process for Making Cured Three-Dimensional Articles

These compositions of the present inventions can be made into cured three-dimensional solid articles with any suitable image projection system, including those that employ BenQ PB7230 projectors. Because these compositions contain both a visible light range free radical photoinitiator and a UV light range free radical photoinitiator, it is desirable to use a UV light source in conjunction with an image projection system. The UV light source can be used (i.e., the resin source can be exposed to that UV light source) before or after or together with the visible light source of the image projection system. The UV light source removes the tackiness of parts in a post-curing of built parts while the parts are in the image projection system, thus creating a dry part handling system for the operator. Of course, a person ordinarily skilled in the art would be aware that it is necessary, for each chosen light source, to select the appropriate photoinitiator and species of the above-noted components as well as run the image projection system at the preferred operations conditions to achieve the most desired results.

It is believed that such cured products are useful in the same manner as the cured products of various stereolithographic systems.

The present invention is further described in detail by means of the following comparisons and example. All parts and percentages are by weight and all temperatures are degrees Celsius unless explicitly stated otherwise.

### COMPARISONS 1 AND 2 AND EXAMPLE 1

The trade names of the components as indicated in the Examples

TABLE 1
List of material identities and chemical compositions.

| TRADE NAMES | CHEMICAL DESIGNATION |
|---|---|
| SARTOMER CN9011 | Aliphatic urethane diacrylate |
| | oligomer |
| SARTOMER SR 833S | Tricyclodecane dimethanol |
| | diacrylate monomer |
| CYTEC EBECRYL 83 | Amine-modified multi-functional |
| | acrylated polyester oligomer |
| SARTOMER CN2302 | Hyperbranched polyester acrylate |
| | oligomer |
| CYTEC EBECRYL 350 | Silicone polyacrylate |
| CIBA IRGACURE I-184 | 1-Hydroxycyclohexyl phenyl ketone |
| CIBA IRGACURE I-819 | Bis (2,4,6-trimethyl benzoyl)- |
| | phenylphosphine oxide |
| PENN COLOR 9W7 | White pigment paste |
| CIBA IRGACURE I-907 | 2-methyl-1-(4-methylthio)phenyl- |
| | 2-morpholino-propan-1-one |
| CYTEC EBECRYL 80 | Amine-modified polyester |
| | tetraacrylate |
| CYTEC ADDITOL ITX | Isopropyl thioxanthone |
| CYTEC MODAFLOW | Acrylic oligomer |
| DEGUSSA AEROSIL R202 | Fumed silica |
| SARTOMER CN2881 | Highly branched multifunctional |
| | polyester acrylate |

The formulations indicated in the Comparisons and Example below were prepared by mixing the components with a stirrer at 60° C. in a glass container until all photoinitiators were dissolved and a homogeneous composition was obtained. These dissolved formulations of the Comparisons 1 and 2 and Example 1 were then added into separate V-FLASH system cartridges of the type described in the above-noted US Patent Applications and then each formulation was used to produce different three-dimensional objects in a V-FLASH system of the type described in the above-noted US Patent Applications under the same operating conditions. The V-FLASH system was equipped with BenQ PB7230 projector visible light image projection system and a TEFLON-like transfer film. All of the produced three-dimensional objects were then cleaned with isopropyl alcohol and then completely cured with a UV light source. Visual observations as noted below were made of these produced three-dimensional objects.

### COMPARISON 1

The following components are similar to those disclosed in U.S. Pat. No. 7,358,283 and were mixed to produce a homogeneous liquid composition:

TABLE 2
List of components, percentage by weight.

| COMPONENT | PERCENTAGE (by wt.) |
|---|---|
| SARTOMER CN9011 | 23.74 |
| SARTOMER SR 833S | 35.61 |
| CYTEC EBECRYL 83 | 23.63 |
| SARTOMER CN2302 | 9.50 |
| UCB EBECRYL 350 | 1.00 |
| CIBA IRGACURE I-907 | 3.56 |
| CIBA IRACURE I-819 | 2.85 |
| PENN COLOR 9W7 | 0.11 |
| Total | 100 |

Three dimensional articles produced by above procedure with the formulation of this Comparison 1 were observed to consistently have missing features. These missing features resulted from observed defects occurring in the resin coating films such as fisheye, craters, and the like. These defects were believed to be caused by dewetting of the resin coating films from the TEFLON-like transfer film. These defects would prevent these articles from being used commercially.

### COMPARISON 2

The following components are similar to the compositions disclosed in U.S. Pat. No. 7,358,283 and were mixed to produce a homogeneous liquid composition:

TABLE 3
List of all components, parts by weight and percentage by weight.

| COMPONENT | PERCENTAGE (by wt.) |
|---|---|
| SARTOMER CN9011 | 28.28 |
| SARTOMER SR 833S | 39.01 |
| CYTEC EBECRYL 83 | 37.72 |
| SARTOMER CN2881 | 8.03 |
| CYTEC MODAFLOW | 0.52 |
| CIBA IRGACURE I-184 | 1.96 |
| CIBA IRGACURE I-819 | 1.52 |
| CYTEC ADDITOL ITX | 0.09 |
| Total | 100.00 |

Three dimensional articles produced by above procedure with the formulation of this Comparison 2 were observed to consistently have missing features. These missing features resulted from observed defects occurring on the resin coating films such as fisheye, craters, and the like. These defects are believed to be caused by dewetting of the resin coating films from the TEFLON-like transfer film. These defects could prevent these articles from being used commercially.

### EXAMPLE 1

The following components were mixed to produce a homogeneous liquid composition:

TABLE 4
List of all components, parts by weight and percentage by weight.

| COMPONENT | PERCENTAGE (by wt.) |
|---|---|
| SARTOMER CN9011 | 28.28 |
| SARTOMER SR 833S | 39.01 |
| CYTEC EBECRYL 83 | 4.88 |
| CYTEC EBECRYL 80 | 9.75 |
| SARTOMER CN2302 | 9.75 |
| CIBA IRGACURE I-184 | 3.66 |
| CIBA IRGACURE I-819 | 2.93 |
| PENN COLOR 9W7 | 0.59 |
| CYTEC MODAFLOW | 0.24 |
| CYTEC ADDITOL ITX | 0.05 |
| DEGUSSA AEROSIL R202 | 0.88 |
| Total | 100.00 |

Three-dimensional articles produced by the above procedure with the formulation of this Example 1 were observed to consistently have full features. Also, no defects were observed on the resin coating films in the V-FLASH system. No dewetting of the resin on the TEFLON-like transfer film was observed. The absence of these defects would allow these articles to be used commercially.

While the invention has been described above with reference to specific embodiments thereof, it is apparent that many changes, modifications, and variations can be made without departing form the inventive concept disclosed herein. Accordingly, it is intended to embrace all such changes, modifications and variations that fall within the spirit and broad scope of the appended claims. All patent applications, patents, and other publications cited herein are incorporated by reference in their entirety.

That which is claimed:

1. A radiation-curable composition useful for the production of three-dimensional solid articles, the composition comprising:
(A) at least one hyperbranched poly(meth)acrylate compound;
(B) at least one light sensitizer; and
(C) at least one free radical polymerization initiator.

2. The composition of claim 1 wherein the at least one hyperbranched poly(meth)acrylate compound is at least one hyperbranched polyester polyacrylate compound.

3. The composition of claim 1 wherein the at least one hyperbranched polyester poly(meth)acrylate compound is present in an amount from about 3% to about 20% by weight, based on the total amount of the composition.

4. The composition of claim 1 wherein the at least one light sensitizer is at least one thioxanthanone UV light sensitizer.

5. The composition of claim 1 wherein the light sensitizer is present in an amount from about 0.005% to about 1% by weight, based on the weight of the total composition.

6. The composition of claim 1 wherein the at least one free radical polymerization initiator is present in an amount from about 1% to about 10% by weight, based on the total amount of the composition.

7. A radiation-curable straight (meth)acrylate composition useful for the production of three-dimensional solid articles by image projection systems, the composition comprising:
(A) at least one hyperbranched polyester poly(meth)acrylate compound;
(B) at least one UV light sensitizer;
(C1) at least one visible light range free radical polymerization initiator;
(C2) at least one UV light range free radical polymerization initiator.
(D) at least one urethane poly(meth)acrylate compound;
(E) at least one poly(meth)acrylate compound; and
(F) at least one non-hyperbranched polyester poly(meth)acrylate compound.

8. The composition of claim 7 wherein the at least one hyperbranched polyester poly(meth)acrylate compound is present in an amount from about 3% to about 20% by weight, based on the total amount of the composition.

9. The composition of claim 7 wherein the at least one UV light sensitizer is at least one thioxanthanone UV light sensitizer.

10. The composition of claim 7 wherein the light sensitizer is present in an amount from about 0.005% to about 1% by weight, based on the weight of the total composition.

11. The composition of claim 7 wherein the visible light range free radical polymerization initiator(s) is present in an amount from about 0.5% to about 7% by weight, based on the weight of the total composition.

12. The composition of claim 7 wherein the UV light range polymerization initiator(s) is present in an amount from about 0.5% to about 7% by weight, based on the weight of the total composition.

13. The composition of claim 7 wherein the at least one urethane poly(meth)acrylate compound is urethane diacrylate oligomer.

14. The composition of claim 7 wherein the at least one urethane poly(meth)acrylate compound is present in an amount from about 10% to about 40%, based on the weight of the total composition.

15. The composition of claim 7 wherein the at least one poly(meth)acrylate compound is at least one diacrylate monomer.

16. The composition of claim 7 wherein the at least one poly(meth)acrylate compound is present in an amount from about 20% to about 55%, based on the weight of the total composition.

17. The composition of claim 7 wherein the at least one non-branched polyester poly(meth)acrylate compound is at least one amine-modified non-branched polyester polyacrylate compounds.

18. The composition of claim 7 wherein non-branched polyester poly(meth)acrylate compound(s) is present in an amount from about 5% to about 30%, based on the weight of the total composition.

19. A radiation-curable straight (meth)acrylate composition useful for the production of three-dimensional solid articles by image projection systems, the composition comprising:
(A) about 3% to about 20% of at least one hyperbranched polyester poly(meth)acrylate compound;
(B) about 0.005% to about 1% of at least one light sensitizer;
(C1) about 0.5% to about 7% of at least one visible light range free radical polymerization initiator;
(C2) about 0.5% to about 7% of at least one UV light range free radical polymerization initiator;
(D) about 10% to about 40% at least one urethane poly(meth)acrylate compound;
(E) about 20% to about 55% at least one poly(meth)acrylate compound; and
(F) about 5% to about 30% of at least one non-hyperbranched polyester poly(meth)acrylate compound, all percentages based on the weight of the total composition.

20. The composition of claim 1 9 wherein the composition additionally contains about 0.005% to about 1% by weight of at least one pigment-type colorant.

21. The composition of claim 19 wherein the composition additionally contains about 0.05% to about 1% by weight of at least one leveling agent.

22. The composition of claim 1 9 wherein the composition additionally contains about 0.25% to about 2% by weight of at least one fumed silica.
